(19) United States
(12) Patent Application Publication
(10) Pub. No.: US 2024/0199022 A1
(43) Pub. Date: Jun. 20, 2024

(54) VEHICLE ANTI-ROLL-OFF BRAKING SYSTEM AND METHOD

(71) Applicant: Continental Automotive Systems, Inc., Auburn Hills, MI (US)

(72) Inventors: Antonio Minna, JR., Sterling Heights, MI (US); Pedro Henriques, Rochester Hills, MI (US)

(73) Assignee: Continental Automotive Systems, Inc., Auburn Hills, MI (US)

(21) Appl. No.: 18/505,206

(22) Filed: Nov. 9, 2023

Related U.S. Application Data
(60) Provisional application No. 63/387,382, filed on Dec. 14, 2022.

(51) Int. Cl. B60W 30/18; B60W 10/06; B60W 10/18

(52) U.S. Cl. CPC B60W 30/18118; B60W 10/06; B60W 10/18; B60W 2510/10; B60W 2520/06; B60W 2710/0666; B60W 2720/10

(57) ABSTRACT

A system for controlling a vehicle, the system comprises an electronic control unit having a processor circuit that is constructed and arranged, to detect whether the vehicle rolls, detect to which direction the vehicle rolls, detect the gear position of the vehicle. The gear position of the vehicle and the direction are compared to one another to determine that the vehicle rolls to an incorrect direction depending on the detected gear position and depending on the detected direction. The vehicle is brought to a standstill upon determining that the vehicle rolls to an incorrect direction.

### FIELD

The invention relates to a system and a method for controlling a vehicle and avoiding vehicle roll-off, in particular with at least one brake.

### BACKGROUND

### 1. Field

Hill-start assist (HSA), also known as hill-hold control (HHC) or hill-start assist control (HAC) or hillholder, is a name for a driving assistance system in motor vehicles, intended e.g. to avoid vehicle roll-back on a hill.

### 2. Description of Related Art

A hill-start assist (HSA) can be a driving assistance system in motor vehicles, intended to avoid vehicle roll-back on e.g. a hill, by e.g. holding the brake until the clutch is at the friction point, making it easier to start up hill from stationary in manual transmission and automatic transmission automobiles. A hill-holder can e.g. work by holding the brake in position while the driver sets up and activates the first gear to move the car forward from a complete stop, without fear of roll-back.

### SUMMARY

An objective of one or more embodiments is to improve a system and a method for controlling a vehicle and avoiding vehicle roll-off.

In accordance with the principles of a present embodiment, this objective is obtained by providing a system and/or a method, wherein once a vehicle is stopped at a hill (e.g. with HSA not active) and the vehicle starts to roll to opposite direction from driver intention (especially detected based on a vehicle gear position), the system will detect incorrect movement (e.g. based on a wheel(s) direction) and will bring the vehicle to standstill.

A method for controlling a vehicle, the method comprises the steps of: detecting whether the vehicle rolls, detecting to which direction the vehicle rolls, detecting the gear position of the vehicle, comparing the gear position of the vehicle and the direction, determining that the vehicle rolls to an incorrect direction depending on the detected gear position and depending on the detected direction, upon determining that the vehicle rolls to an incorrect direction, bringing the vehicle to standstill.

A system for controlling a vehicle, the system comprises an electronic control unit having a processor circuit that is constructed and arranged, to-detect whether the vehicle rolls, detect to which direction the vehicle rolls, detect the gear position of the vehicle, compare the gear position of the vehicle and the direction, determine that the vehicle rolls to an incorrect direction depending on the detected gear position and depending on the detected direction, bring the vehicle to standstill, upon determining that the vehicle rolls to an incorrect direction.

One or more non-transitory tangible media are encoded with logic for execution by a machine and when executed by the machine operable for: detecting whether a vehicle rolls, detecting to which direction the vehicle rolls, detecting the gear position of the vehicle, comparing the gear position of the vehicle and the direction, determining that the vehicle rolls to an incorrect direction depending on the detected gear position and depending on the detected direction, upon determining that the vehicle rolls to an incorrect direction, bringing the vehicle to standstill.

Other objectives, features and characteristics of the embodiments, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The embodiments will be better understood from the following detailed description of the preferred embodiments thereof, taken in conjunction with the accompanying drawings, wherein like reference numerals refer to like parts, in which:

FIG. 1 is a schematic view of a system for avoiding undesired roll off to an undesired direction of a vehicle in accordance with an embodiment of the invention.

FIG. 2 is a schematic view of vehicle, with a system for avoiding undesired roll off of a vehicle in in accordance with an embodiment.

### DETAILED DESCRIPTION OF EMBODIMENTS

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the disclosure. The following detailed description is, therefore, not to be taken in a limiting sense but defined by the appended claims and their legal equivalents.

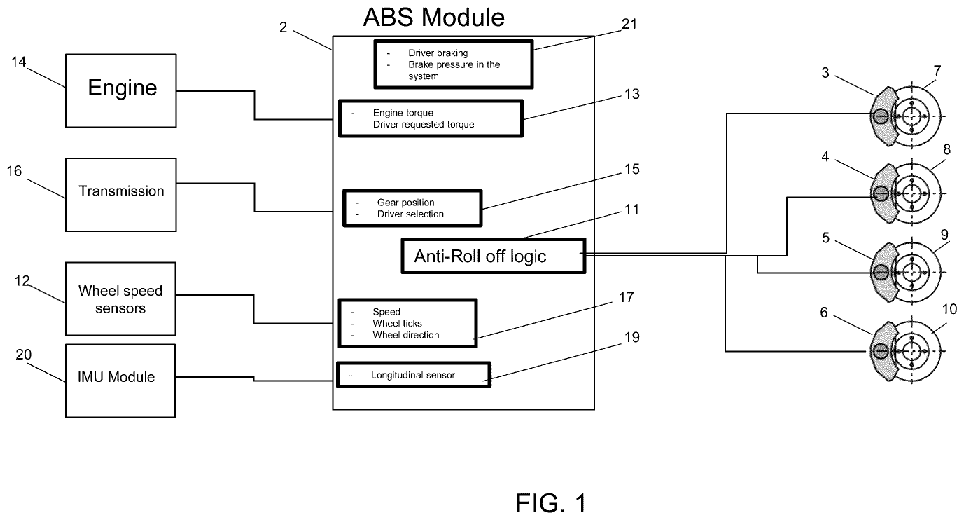

Referring to FIG. 1, a system for controlling anti-roll-off of a vehicle is shown generally indicated at 1 in accordance with an embodiment.

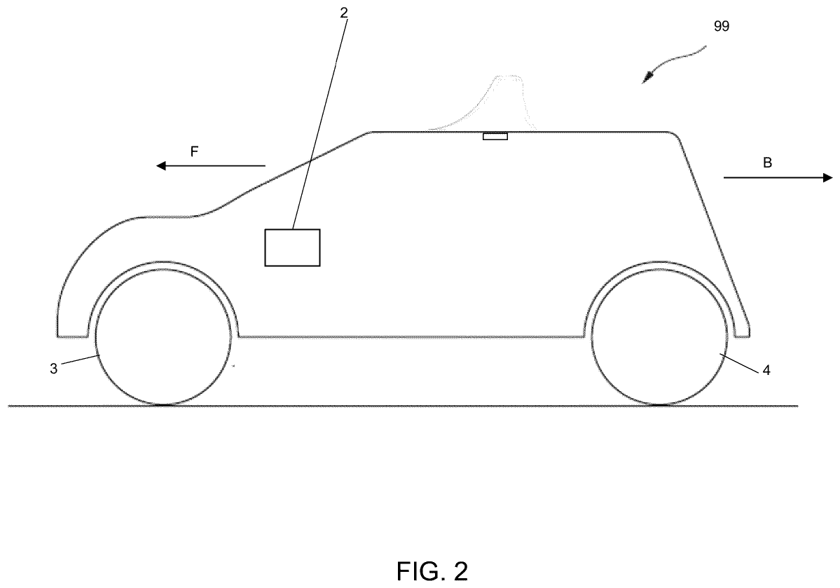

The system can be implemented in a vehicle shown in FIG. 2 generally indicated at 99 in accordance with an embodiment.

Referring to FIG. 1, the system 1 includes an electronic braking system (e.g. an ABS module) generally indicated at 2 and a vehicle anti-roll-off braking system (logic) 11 associated there-with.

The control system and/or braking system 2 can e.g. be of the type disclosed in Patent Application Publication US 2020/0001846 A1, the contents of which is hereby incorporated by reference.

The braking system 2 embodiment comprises brake cylinders 3, 4, 5, 6 10 (e.g. at least one brake cylinder 3, 4, 5, 6 10 per wheel 7, 8, 9, 10 of the vehicle 99) actuated by an electronic braking system 2 (with e.g. an ABS module 2) depending on e.g. an actuation pedal or brake pedal 6 of the vehicle (e.g. car or truck) and a driver braking system control 21.

An engine control device 13, e.g. an ECU, is configured to detect the engine torque of an engine 14 of the vehicle 99. The engine control device 13 is configured to detect a driver requested torque, e.g. depending on a pedal of the vehicle 99.

A gear control device (or transmission control device) 15, e.g. an ECU, is configured to detect the gear position of the gear of the vehicle 99, e.g. a forward gear (or “D”) gear indicating a (correct/intended) forward vehicle direction (F in FIG. 2) desired by a driver of the vehicle 99, or a reverse gear (or “R”) indicating a (correct/intended) backward vehicle direction (B in FIG. 2) desired by a driver of the vehicle.

Wheel speed sensors 12 are arranged on each wheel 3, 4, 5, 6 of the motor vehicle 99.

Wheel speed sensors 12 are arranged to detect whether the vehicle 99 rolls, especially by detecting the (forward or backward) direction and/or speed of the rolling wheels.

A wheel speed detection device 17 is configured to detect speed of one or more wheel speed sensors 12 of the vehicle 99 and/or wheel speed ticks and/or the wheel direction of wheels 3, 4, 5, 6 of the vehicle 99, e.g. related to a forward direction F or a backward direction B of the vehicle 99.

Further the system 2 can comprise an IMU module 20 (inertial measurement unit) e.g. for detecting the direction and speed the vehicle rolls, either additionally to the wheel speed sensor device 17 or instead of it.

If the direction (B or F) detected by the gear control device 15 is different to the direction (F or B) detected by the wheel speed sensors 12 and/or by the wheel speed sensor device 17 and/or by the IMU module 20, that can be a detection that the vehicle 99 rolls into an incorrect direction (e.g. a direction different to the direction the driver of the vehicle is assumed to desire to drive now or after hitting the gas pedal). E.g. if the gear control device 15 detects a (gear and/or desired) forward direction F, but wheel speed sensor device 17 detects a (vehicle) backward rolling direction B, that can be a detection that the vehicle 99 rolls into an incorrect direction. E.g. if the gear control device 15 detects a (gear and/or desired) backward direction B, but wheel speed sensor device 17 detects a (vehicle) forward direction F, that can determine that the vehicle 99 rolls into an incorrect direction.

Upon determining that the vehicle 99 rolls into an incorrect direction, the control and/or brake system 2 can bring the vehicle to standstill, e.g. by activating one or more or all brakes 3, 4, 5, 6 of the vehicle 99 and/or by either increasing or reducing idle torque of the vehicle's engine.

Generally, an anti-roll off logic 11 can compare the detected direction F or B the vehicle 99 rolls, to the gear position of the vehicle, determining that the vehicle 99 rolls to an incorrect direction F or B depending on the detected gear position and depending on the detected direction (that the vehicle rolls). Upon determining that the vehicle rolls to an incorrect direction, bringing the vehicle to standstill.

During some situations the vehicle could roll and the parking brake could apply. The parking brake could e.g. take 3 or more seconds to clamp and the vehicle will travel a few meters before the parking brake can be fully applied.

If a vehicle stops on a high inclination or if there is a reduced transmission drag like (DSG transmissions) it may be possible that the vehicle starts to roll in an opposite direction of travel than the driver intended. This could lead to engine stall and some driver panic.

One other situation that could solve is that to save energy, so the vehicle is reducing idle torque which needs to be translated to increase of brake torque. This invention provides an easy detection of engine drag reducing holding the vehicle in place.

Using wheel speed and direction one can define what is the vehicle state and travel direction. With gear position information one can detect if the vehicle is moving in the desired direction of if holding is necessary (preventing the vehicle to roll e.g. backwards).

Once the detection is triggered one can apply pressure in e.g. 100 ms. The invention can be useful in any field with an item that would have a wheel speed sensor and directional gearing.

According to an embodiment, a detection of the vehicle moving in a direction the opposite to the driver intended might be useful.

Standstill can mean full standstill at zero speed or a reduced speed.

What is claimed is:

1. A method for controlling a vehicle comprising:
detecting whether the vehicle rolls,
detecting to which direction the vehicle rolls,
detecting the gear position of the vehicle,
comparing the gear position of the vehicle and the direction,
determining that the vehicle rolls to an incorrect direction depending on the detected gear position and depending on the detected direction, and
upon determining that the vehicle rolls to an incorrect direction, bringing the vehicle to standstill.

2. The method of claim 1, wherein the detecting whether the vehicle rolls, comprises detecting a wheel speed of at least one wheel of the vehicle.

3. The method of claim 2, wherein the detecting whether the vehicle rolls, comprises detecting a wheel speed of at least one wheel of the vehicle with a wheel speed sensor of the car.

4. The method of claim 1, wherein the determining that the vehicle rolls to an incorrect direction comprises comparing the detected gear position and the detected direction, and determining that the vehicle rolls to an incorrect direction, if the detected gear position and the detected direction are different.

5. The method of claim 1, wherein the bringing the vehicle to standstill comprises activating one or more brakes of the vehicle.

6. The method of claim 1, wherein the bringing the vehicle to standstill comprises the vehicle increasing idle torque of the vehicle's engine.

7. The method of claim 1, wherein the bringing the vehicle to standstill comprises the vehicle increasing the brake torque of at least one brake of the vehicle.

8. The method of claim 1, wherein vehicle moving to an incorrect direction means the vehicle moving to a direction different to the direction indicated by the gear position of the vehicle.

9. The method of claim 1, wherein the method is activated only or also, when a hill-start assist HSA not active) system is not active or is deactivated in the vehicle.

10. A system for controlling a vehicle, the system comprising:
an electronic control unit having a processor circuit that is constructed and arranged, to
detect whether the vehicle rolls,
detect to which direction the vehicle rolls,
detect the gear position of the vehicle,
compare the gear position of the vehicle and the direction,
determine that the vehicle rolls to an incorrect direction depending on the detected gear position and depending on the detected direction, and
bring the vehicle to standstill, upon determining that the vehicle rolls to an incorrect direction.

11. The system of claim 10, wherein the standstill device is constructed and arranged to bring the vehicle to standstill by a device constructed and arranged to deliver a pressure medium to wheel brakes of the vehicle.

12. The system of claim 10, wherein the standstill device is constructed and arranged to bring the vehicle to standstill by a device constructed and arranged to increase idle torque of the vehicle's engine.

13. One or more non-transitory tangible media encoded with logic for execution by a machine and when executed by the machine operable for:
detecting whether a vehicle rolls,
detecting to which direction the vehicle rolls,
detecting the gear position of the vehicle,
comparing the gear position of the vehicle and the direction,
determining that the vehicle rolls to an incorrect direction depending on the detected gear position and depending on the detected direction, and
upon determining that the vehicle rolls to an incorrect direction, bringing the vehicle to standstill.
